(19) United States
(12) Patent Application Publication
(10) Pub. No.: US 2016/0036049 A1
(43) Pub. Date: Feb. 4, 2016

(54) LITHIUM ION BATTERY ELECTRODE MATERIAL WITH COMPOSITE FUNCTIONAL COATING

(71) Applicant: Hong Kong Applied Science and Technology Research Institute Co., Ltd., Shatin (HK)

(72) Inventors: Bin Wang, Hong Kong (CN); Yingkai Jiang, Shenzhen City (CN); Lai Fan Man, Hong Kong (CN); Pauyee Lim, Hong Kong (CN)

(21) Appl. No.: 14/796,816

(22) Filed: Jul. 10, 2015

Related U.S. Application Data
(60) Provisional application No. 62/030,936, filed on Jul. 30, 2014.

(51) Int. Cl. H01M 4/36; H01M 4/46; H01M 10/0525; H01M 4/134; H01M 4/04; H01M 4/133; H01M 4/38

(52) U.S. Cl. CPC H01M 4/366; H01M 4/133; H01M 4/466; H01M 4/38; H01M 4/134; H01M 4/463; H01M 4/387; H01M 4/04; H01M 4/049; H01M 10/0525; H01M 2220/30; H01M 2220/20

(57) ABSTRACT

A method of coating electrode material, for a lithium ion battery, that involves chemically grafting an organic layer to the electrode material. The method includes carbonizing the organic layer to form a doped carbon layer chemically bonded to the electrode material. A dopant included in the carbon layer is adapted to react with harmful material formed in the operation of the lithium ion battery and thereby protect the electrode material. Further, a dopant included in the carbon layer may improve the carbon layer's conductivity. A lithium ion battery that includes an electrode fabricated from electrode material that has doped carbon chemically bonded to the electrode material. A dopant included in the doped carbon is capable of reacting with harmful products formed in the electrolyte of the lithium ion battery during its charging and discharging process. A dopant included in the doped carbon improves electron transfer and thereby improves conductivity of the electrode material and the electrode fabricated from the electrode material.

### RELATED APPLICATIONS

The present Non-Provisional application claims priority to Provisional Application No. 62/030,936 entitled “METHOD OF MAKING POROUS COATING ON ELECTRODE MATERIALS FOR LITHIUM ION BATTERIES,” filed Jul. 30, 2014, the disclosure of which is incorporated herein by reference.

### TECHNICAL FIELD

The current disclosure generally relates to the field of batteries. More specifically, the disclosure relates to improving lithium ion batteries by providing new types of coating and coating techniques for protecting electrode materials and increasing electrode conductivity of the lithium ion batteries.

### BACKGROUND

Many modern devices require a battery as a mobile source of electrical energy. Because of this mobile source of energy, devices such as computers, flashlights, watches, and other devices that require electrical energy can be portable. Even when a battery is not the primary source of energy for a device, it nonetheless may still be required for that device. For instance, most motor vehicles are primarily powered by burning fuel, but these motor vehicles still require a battery to get the engines of the motor vehicles started. Primarily because of environmental concerns, motor vehicles are now being built to use batteries as the primary source of energy—instead of fuel. Thus, batteries and battery technology are becoming more and more prevalent and important.

There are various types of rechargeable batteries available. The basic concept common to rechargeable batteries is that they have electrochemical cells that reversibly convert chemical energy to electrical energy. Each of these cells has a positive terminal (anode) from which electrons flow through an external circuit to a negative terminal (cathode). This flow of electrons causes an electrical current. A device may be attached to the cathode and the anode to provide that electrical current to the device.

Because lithium ion batteries have certain advantages over other types of rechargeable batteries, they are becoming increasingly popular and are now widely applied in equipment such as mobile phones, computers, and electrical vehicles. FIG. 1 illustrates prior art lithium ion battery 10 and its working principle. The primary components of lithium ion battery 10 include anode 100, cathode 101, electrolyte 102, and separator 103.

Separator 103 acts as a barrier between anode 100 and cathode 101 and thereby prevents short-circuiting between anode 100 and cathode 101. Cathode 101 is typically lithium cobalt oxide; and anode 100 is typically graphite or tin based materials. During the process of charging lithium ion battery 10, lithium ions will be released into electrolyte 102 from cathode 101 and travel to anode 100, from the left side of FIG. 1 to the right side of FIG. 1. Electrons will also spontaneously move from cathode 101 to anode 100 via an external circuit. During the discharge process, the lithium ions at anode 100 and electrons will move from anode 100 to cathode 101, from the right side of FIG. 1 to the left side of FIG. 1. Simultaneous transportation of lithium ions and electrons between anode and cathode is important for the lithium ion battery's charging and discharging processes.

There is a desire, in the art, to make lithium ion batteries so that they have high energy density. In view of the pursuit of high energy density, the electrode materials (anode materials and cathode materials) have become an important area of focus because they have a significant impact on the energy density of the lithium ion battery. In addition to energy density, the electrode materials, to a large extent, determine the lithium ion battery's capacity.

Table 1 shows some materials typically used as cathode active materials and anode active materials and their respective conductivities. From Table 1, it can be seen that the conductivities for some of the typical cathode electrode materials and advanced anode electrode materials used in lithium ion batteries are relatively low compared with carbon materials.

TABLE 1

| Active Material | Cathode/Anode | Conductivity (S/cm) |
|---|---|---|
| LiCoO₂ | Cathode | 2.0 × 10⁻¹ |
| LiFePO₄ | Cathode | 1.9 × 10⁻⁹ |
| SiO₂ | Anode | 1.0 × 10⁻¹¹ |
| SnO₂ | Anode | 1.0 × 10⁻³ |
| Carbon | N/A | 1.0 × 10⁴ |

As can be seen from Table 1, the chemical formula for the cathode materials show that lithium (Li) is an element of the cathode materials. Table 1 also shows that the anode materials may be a metal oxide.

In operation of lithium ion battery 10, electrolyte 102, when working at high voltage, 4.8V and above, decomposes according to the following equation, in which LiPF₆ is the major solute of electrolyte, widely used in lithium ion batteries:

LiPF₆+H₂O→LiF+POF₃+2 HF (Equation 1)

The decomposition process, which occurs during charge/discharge, forms hydrogen fluoride (HF). In turn, the hydrogen fluoride attacks (reacts with) the lithium cobalt oxide of cathode 101:

4 HF+LiCoO₂→LiF+CoF₃+2H₂O (Equation 2)

Equation 2 shows dissolution of lithium cobalt oxide from the cathode to form cobalt fluoride. The cobalt fluoride is in electrolyte solution. This dissolution of cobalt from the cathode to the electrolyte disintegrates the cathode and causes performance deterioration of the battery.

Coating materials of electrodes is one effective method of addressing the dissolution of electrode materials as a result of the harmful by-products of the charging/discharging processes. Disadvantages of coating layers in current technologies include complicated fabrication processes, single component coating layers, and non-uniform coating layers. Many developed coating methods including sol-gel, ball milling, wet mixing, chemical vapor deposition, spray pyrolysis, electrospinning and hydrothermal methods have high fabrication costs and high energy consumption. Most of the current coating layers are pure component layers on the surface and are not effective in protecting the electrode materials from dissolution during the charge/discharge process.

For example, attempts have been made to use carbon as a protective coating for electrode materials. But carbon is inert, and, because of this, it does not effectively protect the electrode materials from chemical dissolution. The carbon, at best, may provide a temporary barrier between the HF and the electrode material. If the carbon is porous, the HF, in solution, ultimately comes in contact with the electrode and attack the electrode material. Another method of addressing the issue of dissolution of electrode material in lithium ion batteries is the use of metal oxides as scavengers to react with HF. However, the use of metal oxides on the coating layer will significantly increase the resistivity of electrode materials.

An issue for current methods of electrode coating is that the resulting coating layer is usually non-uniform. This is so especially when those coating layers have been applied by a physical method, such as ball milling and spray pyrolysis. The relatively thin sections of the non-uniform layer are its weak points because they may provide HF the opportunity to get to and react with core active materials.

The quality, structure, and features of coating layers of electrode materials are important for battery performance. Thus, improvements in coatings for battery electrodes are always desired in the art of battery fabrication.

### BRIEF SUMMARY

The present disclosure is directed to apparatus, systems, and methods to protect electrode materials of batteries by providing a sacrificial agent for reacting with corrosive or harmful by-products that are formed in the battery. Embodiments of the disclosure may find application in high energy density lithium ion batteries working at high voltage. The sacrificial agent may be provided in a coating layer that is adapted to improve the coating layer's conductivity and may be further adapted such that it is chemically bonded to the electrode material that is being protected.

In embodiments of the invention, a dopant is provided in the coating layer, on material of the component being protected (e.g. electrodes) as the sacrificial agent. The sacrificial agent may be a metal or a metalloid. For example, in embodiments in which the corrosive by-product is hydrogen fluoride, a metal dopant or a metalloid dopant may be provided in the coating layer on the electrode material to scavenge the hydrogen fluoride. In this way, the hydrogen fluoride does not come in direct contact with electrode materials, thus preventing dissolution of electrode materials. In other words, the dopant in the coating layer acts as a protector of the electrode material from the corrosive by-products of the electrochemical process that takes place in the battery.

Embodiments of the invention involve coating electrode material of a lithium ion battery with material that is primarily carbon. The carbon may be co-doped with a metal or a metalloid to provide a sacrificial agent. In addition, the carbon may be doped with a non-metal element having a valency different from carbon's valency (e.g. greater than carbon's valency or greater than a pre-determined threshold) (e.g. nitrogen, phosphorus having a valency of +5). Doping the carbon with a non-metal element having a valency different from carbon's valency, such as a valency greater than carbon's valency (e.g. nitrogen or phosphorus having a valency of +5) improves the conductivity of the carbon coating. Using carbon as a coating in this manner may be considered to be composite functional coating because, although the material is primarily carbon, it is not pure carbon. The carbon, according to embodiments of the invention, includes other material, namely metal, metalloid, nitrogen, phosphorus, or combinations thereof, as dopants. These dopants may be derived from organic compounds with functional groups. The organic compounds are used in reactions to form a self-doped coating layer, which can protect electrode materials from side reactions and improve conductivity of electrode materials.

In addition to the nature of the material used for the coating, the present disclosure presents a method, of applying the coating material, which utilizes chemical bonding between coating material and electrode material. Thus, embodiments of the invention include coating electrode materials for a battery by chemically bonding doped carbon to the electrode materials. This may include first chemically bonding an organic layer to the electrode material and then converting the organic layer to the doped carbon. Embodiments of the invention include a battery that has an electrode with material that has doped carbon chemically bonded to the electrode material.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 illustrates a prior art lithium ion battery and its working principle;

FIG. 2 illustrates a process according to embodiments of the invention;

FIG. 3 illustrates a process according to embodiments of the invention;

FIG. 4 illustrates a process according to embodiments of the invention;

FIG. 5 illustrates coated electrode material according to embodiments of the invention;

FIG. 6 illustrates a lithium ion battery according to embodiments of the invention;

FIGS. 7A and 7B shows transmission electron microscope (TEM) images of electrode material before and after coating according to embodiments of the invention;

FIG. 8A shows high resolution Si2p XPS spectra of Li_{1.2}Mn_{0.6}Ni_{0.2}O₂ (lithium rich cathode material, LRCM) before (solid symbol) and after (open symbol) coating;

FIG. 8B shows N1s XPS spectra of Li_{1.2}Mn_{0.6}Ni_{0.2}O₂ (lithium rich cathode material, LRCM) before (solid symbol) and after (open symbol) coating;

FIG. 9 illustrates electrochemical impedance spectroscopy (EIS) pertaining to electrode material before and after coating according to embodiments of the invention; and

FIG. 10 illustrates a process according to embodiments of the disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Lithium ion batteries with high working voltages are advantageous in the art. However, in lithium ion batteries operated at high voltages, e.g. at 4.8 volts or higher, the electrolyte of the battery will start to decompose. As described above, this decomposition, which occurs during the charge/discharge processes of the battery, produces corrosive hydrogen fluoride, HF. As noted above, this hydrogen fluoride is very harmful for electrode materials. For example, HF may react with lithium cobalt oxide, LiCoO₂ so that there is dissolution of the cobalt from the electrode into the electrolyte.

In seeking to address the problem of by-products such as hydrogen fluoride reacting with electrode materials of the lithium ion battery, the present inventors recognized that a consideration for a material to be used to coat electrode materials to prevent reaction of the electrode with harmful by-products is whether that coating material has high electrical conductivity. Another consideration is the electrical conductivity of the coated electrode material and an electrode fabricated from the electrode material, as a whole. In certain contexts, it may be desirable to fabricate batteries with electrodes that have high conductivity (low resistivity).

Embodiments of the invention provide sacrificial material or a scavenger for reacting with harmful or corrosive by-products that are formed in a cell of a battery. In this way, the corrosive material, e.g. hydrogen fluoride, does not react with electrode material to cause dissolution from the electrode material. Embodiments of the invention may provide the sacrificial material around the surface of the electrode material. For example, a protective layer may be adapted so that the protective layer provides a barrier between the corrosive material and the electrode material. The protective layer may also be adapted so that sacrificial material may be around the electrode material, or on the surface of the electrode material, or both, to react with the harmful or corrosive by-products. The above described protective layer may also be adapted to improve its conductivity such that protecting the electrode material does not result in an increase in resistance of the electrode material and the electrode as a whole. Further, the protective layer may be attached to the electrode materials by chemical bonds.

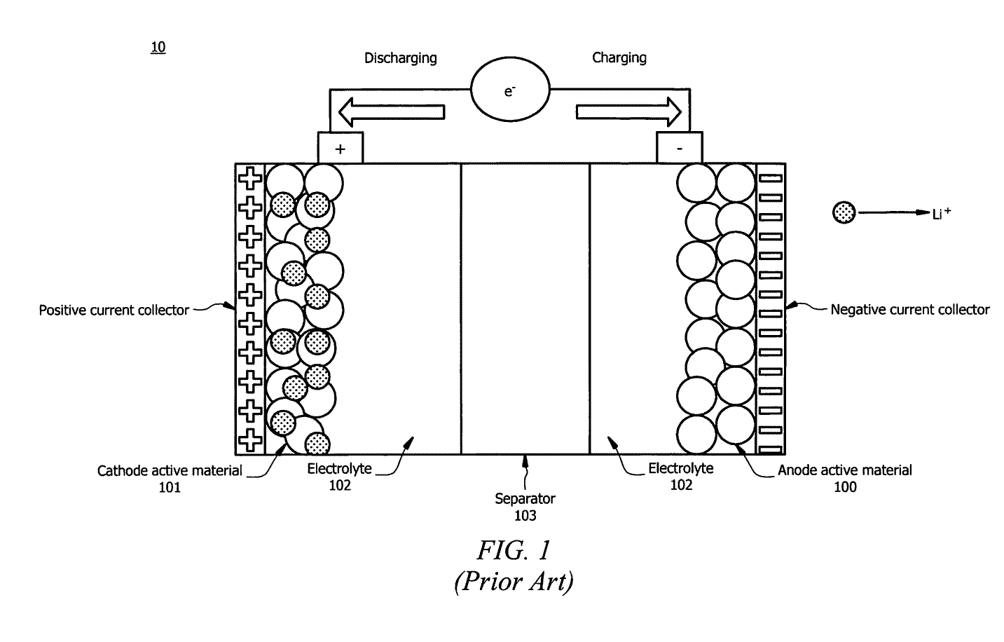

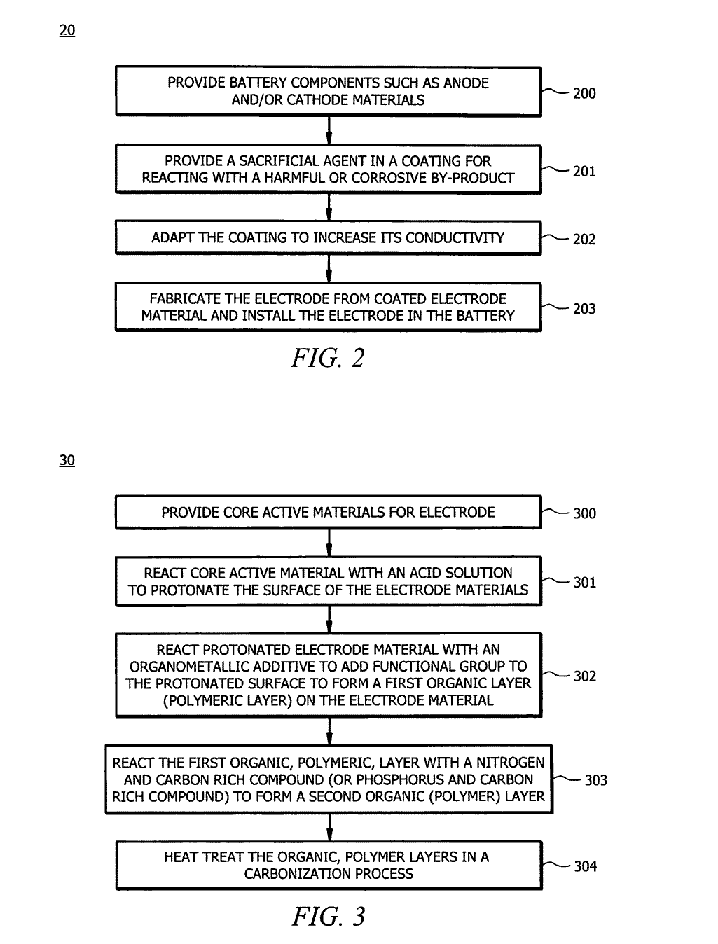

FIG. 2 shows process 20 according to embodiments of the invention. Process 20 provides protection for, and improves the conductivity of, the electrodes of a lithium ion battery. Process 20 may begin at block 200, which involves providing materials for lithium ion batteries by manufacturing methods known in the art. Block 200 may involve providing materials for battery components such as electrodes (anodes and cathodes), electrolyte, and separator (similar to the elements described and shown with respect to lithium ion battery 10 of FIG. 1). At block 201, the electrode material is provided with a sacrificial agent, in a coating of the electrode material, for reacting with corrosive by-products that may be formed during operation of the lithium ion battery (e.g. corrosive by-products formed during the charging/discharging process). Block 202 may involve adapting the coating material to improve its conductivity. It should be noted that processes of block 201 and block 202 may take place at the same time. At block 203, the coated electrode material, which includes the sacrificial agent, is used to fabricate one or more electrodes.

For example, the electrode (e.g. cathode) may be made from a slurry comprising 94% coated Li_{1.2}Mn_{0.6}Ni_{0.2}O₂ (lithium rich cathode material; LRCM), 3% acetylene carbon black (Super P) and 3% polyvinylidene fluoride (PVDF) in N-methyl-2-pyrrolidone (NMP). The resultant slurry may be uniformly spread onto aluminum foil (current collector) by a film applicator and vacuum dried at 120° C. for 12 hours to form the electrode. The electrode material, and the other components, e.g. electrolyte, separator etc., as noted above, may be installed in the lithium ion battery to form a lithium ion battery similar to lithium ion battery 10, except that the electrode material that forms the electrode is coated as described herein.

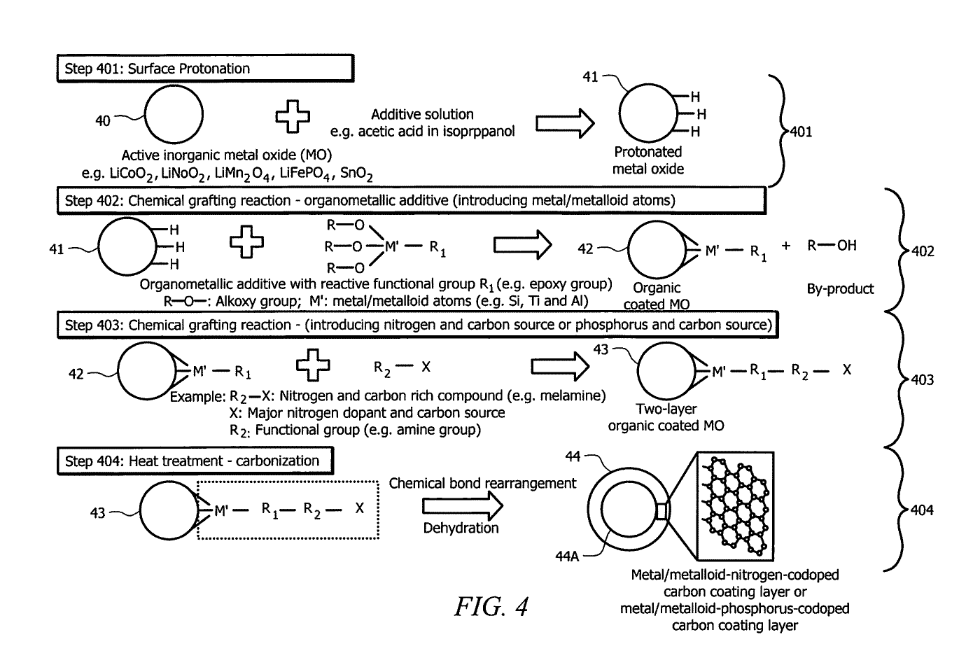

FIG. 3 shows process 30 according to embodiments of the invention. Process 30 provides protection for, and improves the conductivity of, the electrodes of a lithium ion battery. Process 30 may begin at block 300, which involves providing core active materials for electrodes of lithium ion batteries by manufacturing methods known in the art. Other materials for a lithium ion battery may also be provided. Such materials may include electrolyte and separator (similar to the elements described and shown with respect to lithium ion battery 10 of FIG. 1). The core active material may be inorganic metal oxides (MO), metal phosphates, metal sulfides, or combinations thereof. The core active material may be active inorganic metal oxides and metal phosphates such as LiCoO₂, LiNiO₂, LiMn₂O₄, LiFePO₄, and SnO₂. In FIG. 4, core active material 40 is shown with a spherical shape, but it may be of any shape. In embodiments of the invention, the core active material may be Li_{1.2}Mn_{0.6}Ni_{0.2}O₂ (lithium rich cathode materials) nanoparticles with a typical size of about 200 nm.

Process 30 involves producing a doped carbon coating for electrode material of a lithium ion battery by using chemical grafting reactions and a subsequent carbonization process. The chemical grafting reactions and carbonization process are described below with respect to the description of blocks 301-304. At block 301, core active material 40 is reacted with an additive solution to protonate core active material 40. A surface protonation reaction is shown in process step 401 of FIG. 4, according to embodiments of the invention. The additive solution may be a weak acid solution, for example, any one of acetic acid, oxalic acid, formic acid, and citric acid in solvent such as any one of, isopropanol, methanol, ethanol, isopropanol, or acetone, or combinations thereof. The surface protonation reaction creates one or more functional groups on core active material 40. In this way, the surface of core active material 40 is covered with hydroxyl groups. The protons from the acid react with surface oxygen from metal oxides or metal phosphates, and, thereby, form a protonated surface. As shown in process step 401, core active material 40 forms chemical bonds with hydrogen to form protonated core active material 41 (protonated metal oxide or protonated metal phosphate). Core active material may include a metal oxide, a metal phosphate, a metal sulfide, similar materials used in lithium ion batteries as active material, or combinations thereof. As described further below, the chemical bonding described above provides advantages in the art as compared with other methods of coating core active materials.

Block 302 involves a chemical grafting reaction, as illustrated by process step 402, in which protonated core active material 41 (protonated metal oxide or protonated metal phosphate) is reacted with an organometallic additive. In this way, metal/metalloid atoms are introduced into an organic coating of core active material 40. The organometallic additive may have a reactive functional group R₁ (e.g. an epoxy group), an alkoxy group R—O—, and metal atoms or metalloid atoms (e.g. Ti, Al, Si, Sn, Mg, Zn, Zr, and combinations thereof). The organometallic additive may include silane, aluminum, titantium, zirconate, and combinations thereof, as coupling agents. The coupling agents may include functional groups such as epoxy, alkoxy and amine, including bis[2-[(2-aminoethyl)amino]ethanolato] [2-[(2-aminoethy)amino]ethanolato-O] (propan-2-olato)titanate and (3-glycidyloxypropyl)trimethoxysilane, and combinations thereof.

In the chemical grafting reaction of process step 402, organometallic additive reacts with the protonated surface of protonated core active material 41 (protonated metal oxide or protonated metal phosphate) to produce organic coated core active material 42 and a by-product R—OH. Thus, in process step 402, the protonated surface reacts with the additives to form a first organic layer on core active material 40 (metal oxide or metal phosphate). The organic layer encapsulates core active material 40. The hydrogen from the protonated surface reacts with the R—O group to form the by-product, R—OH. Organic coated core active material 42 is core active material 40 (metal oxide or metal phosphate) surrounded by metal atoms or metalloid atoms of an organic layer. The metal atoms or metalloid atoms are chemically bonded to the outside surface of the metal oxide or the metal phosphate.

At block 303, there is another chemical grafting reaction that adds a second organic layer to core active material 40 (an organic layer added to organic coated core active material 42), as further illustrated at process step 403. According to embodiments of the invention, in this chemical grafting reaction, organic coated core active material 42 is reacted with a nitrogen and carbon rich compound to form double organic layer coated core active material 43 (double organic layer coated metal oxide). Further, according to embodiments of the invention, this chemical grafting reaction, involves organic coated core active material 42 being reacted with a phosphorus and carbon rich compound to form double organic layer coated core active material 43 (double organic layer coated metal phosphate). Further, in embodiments of the invention, the chemical grafting reaction, involves organic coated core active material 42 being reacted with both of (1) a nitrogen and carbon rich compound and (2) a phosphorus and carbon rich compound to form double organic layer coated core active material 43 (double organic layer coated metal oxide and double organic layer coated metal phosphate). Process step 403 shows R₂—X as the nitrogen and carbon rich compound or the phosphorus and nitrogen rich compound. X is the source of nitrogen (or phosphorus) dopant and carbon. In addition to nitrogen and carbon, this compound has the functional group R₂.

The introduced compound R₂—X grafts onto the organic coated metal oxide (or organic coated metal phosphate) because of a chemical interaction between R₁ and R₂. Thus, if R₁ is the epoxy group, R₂ may be an amine group and vice versa (i.e. if R₁ is an amine group, R₂ may be an epoxy group). R₂—X may be melamine. The core active material 40 (metal oxide or metal phosphate), subjected to these two steps of chemical grafting, is coated with two layers of organic material.

In embodiments of the invention, block 303 introduces a nitrogen and carbon rich compound to the organic coating layer, as illustrated at process step 403. The nitrogen is a self-dopant because the nitrogen atoms are in the precursor to the doped carbon coating-organic coating layer. That is, nitrogen atoms were already in compounds used in reactions to form the organic coating layer. In this way, the nitrogen atoms do not have to be introduced into the doped carbon coating from some other source outside of the organic layer or doped carbon coating. Introducing nitrogen into a carbon coating from another source may include treating the coating material with ammonium. Thus, in coating materials, according to embodiments of the invention, nitrogen is a self-dopant from the nitrogen rich compound. The nitrogen may originate from melamine used to react with organic coated core active material 42. The nitrogen and carbon source may include a selection from the group consisting of: melamine, polyethyleneimine, polyacrylamide, pyrrole, and combinations thereof.

In embodiments of the invention, a phosphorus and carbon rich compound is included in the reaction in process step 403. Phosphorus is a self-dopant because the phosphorus atoms are in the precursor to the doped carbon coating—organic coating layer. That is, the phosphorus atoms were already in compounds used in reactions to form the organic coating layer. In this way, the phosphorus atoms do not have to be introduced into the doped carbon coating from some other source outside of the organic layer or doped carbon coating.

At block 304 the organic coating, having two layers, is subjected to heat treatment—a carbonization process, as illustrated at process step 404. The carbonization process may be carried out at a temperature of about 400-1200° C. in an atmosphere of any of the following: argon, helium, nitrogen, hydrogen, carbon dioxide, or combinations thereof. At process step 404, the applied heat carbonizes the two organic layers (polymer layers). In the carbonization process of process step 404, organic (polymer) materials are converted into co-doped carbon materials, which form the outer shell protective layer (metal or metalloid, nitrogen or phosphorus co-doped, coating layer) on core active material 40. That is, the carbonization process forms core active material with a co-doped carbon layer 44. In the carbonization process, hydrogen, oxygen, as well as carbon may be decomposed or evaporated from double organic layer coated core active material 43 (double organic layer coated metal oxide or double organic layer coated metal phosphate) in the form of H₂O and CO₂. Thus, most of the metal atoms or metalloid atoms and the nitrogen or phosphorus atoms will be left in coating layer 44A as dopants.

It should be noted that a concentration of the dopants may be determined by the selection of compounds used in the chemical grafting reactions of process steps 402 and 403 that form double organic layer coated core active material 43. For instance, the higher the amount of metal or metalloid in an organometallic compound selected, for the grafting reaction of process step 402, to react with protonated core active material 41, the higher the concentration of metal or metalloid in the organic coated layer of double organic layer coated core active material 43 and the doped carbon (layer 44A) after carbonization, and vice versa. Similarly, the higher the amount of nitrogen in a compound used in the grafting reaction of process step 403 to react with organic coated core active material 42, the higher the concentration of nitrogen in the organic coated layer of double organic layer coated core active material 43 and the doped carbon (layer 44A) after carbonization, and vice versa. Likewise, the higher the amount of phosphorus in a compound used in the grafting reaction of process step 403 to react with organic coated core active material 42, the higher the concentration of phosphorus in the organic coated layer of double organic layer coated core active material 43 and the doped carbon (layer 44A) after carbonization, and vice versa.

As shown at process step 404, electrode material 44 includes core active material 40 and co-doped carbon layer 44A. Layer 44A is primarily carbon with metal dopant or metalloid dopant and nitrogen dopant or phosphorus dopant therein. In other words, the main component of layer 44A is carbon. The metalloid or metal and the nitrogen or phosphorus may be at trace amounts. The metalloid or metal and the nitrogen atoms or phosphorus atoms substitute for carbon atoms at certain points in layer 44A. In embodiments of the invention, the atomic concentration of metal or metalloid in layer 44A is 5% or less. In embodiments of the invention, the atomic concentration of nitrogen in layer 44A is 5% or less. In embodiments of the invention, a phosphorus and carbon rich compound is included in the reaction at process step 403 and the atomic concentration of phosphorus in layer 44A is 5% or less.

In the carbonization process shown in process step 404, hydrogen atoms, oxygen atoms and some of the carbon atoms will be decomposed. Because of the high temperatures used to carry out the carbonization process, the organic polymer material is dehydrated or decomposed. The water formed by the reaction of hydrogen atoms with oxygen atoms is evaporated from the organic layer as water vapor. Some of the carbon atoms may also be decomposed from the organic material to form carbon dioxide. Because most of the organic material is rich in carbon, most of the carbon will be left on the surface of core active material 40, after the carbonization process.

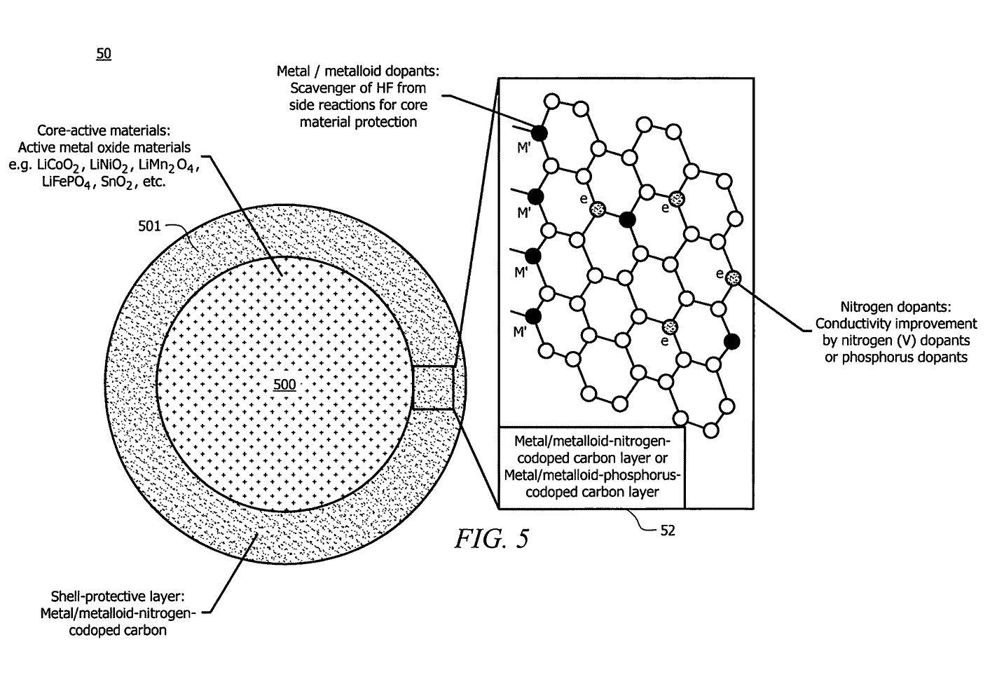

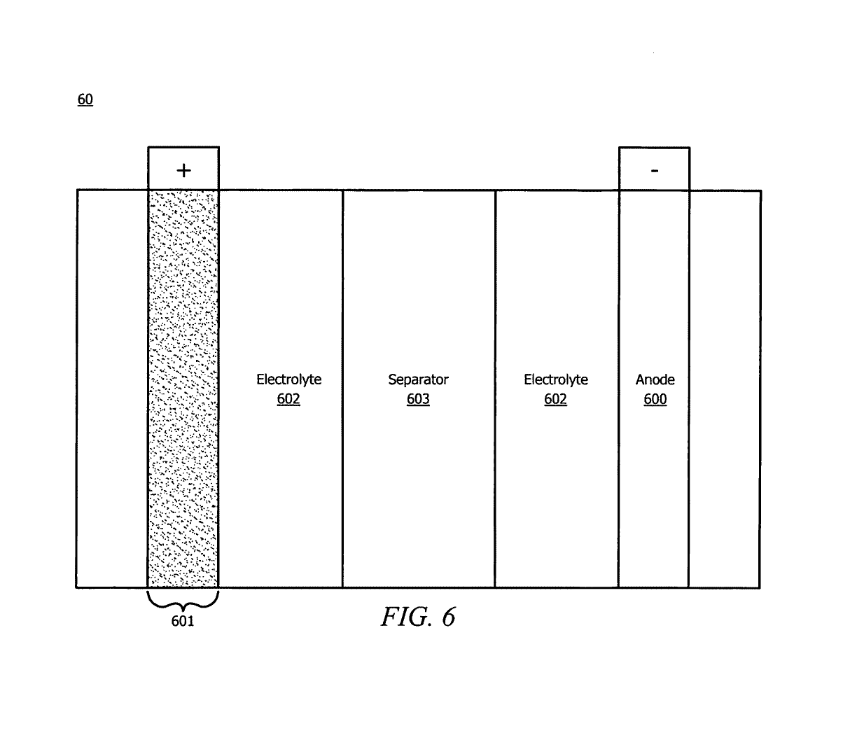

FIG. 5 shows coated electrode material 50 (same as electrode material 44), according to embodiments of the invention. Coated electrode material 50 is made by process 30 as further illustrated by process steps 401-404, as described above. Core active material 500 (same as core active material 40) is encapsulated by shell protective layer 501 (same as layer 44A). Core active material 500 may include active metal oxide or metal phosphate materials such as LiCoO₂, LiNiO₂, LiMn₂O₄, LiFePO₄, LiNiO₂, LiNi_{1/3}Mn_{1/3}CO_{1/3}O₂, LiNi_{0.5}Mn_{0.3}Co_{0.2} O₂, xLi₂MO₃.(1−x)LiMeO₂ (0<x<1, M and Me are independently at least one from Mn, Ni, Co), Fe₃O₄, SnO₂ and combinations thereof. Because of the chemical reactions described in process steps 401-404, shell protective layer 501 is chemically bonded to core active material 500. Core active material 500, the material coated, may be anode material, or cathode material, or both, for a particular lithium ion battery. Shell protective layer 501 may include a composite structure including, (1) metal or metalloid and (2) nitrogen or phosphorus, as co-dopants in carbon.

Shell protective layer 501 concurrently addresses the challenges of (1) protecting core active material 500 from corrosive by-products, such as HF, formed in the cell of a lithium ion battery and (2) providing protective material that, in addition to having a protective function, has high conductivity. In other words, in embodiments of the invention, shell protective layer 501 is bi-functional. The protective function involves protective layer 501 acting as a scavenger of corrosive materials, such as HF, in order to protect core active material 500 from dissolution. In this way, shell protective layer 501 deactivates the unwanted HF by-product.

In embodiments of the invention, metal dopants or metalloid dopants of shell protective layer 501 surrounds core active material 500, on the surface of core active material 500. The other function of shell protective layer 501 may involve nitrogen dopants (or phosphorus dopants) of shell protective layer 501 improving the conductivity of shell protective layer 501 (as compared to pure carbon) and thereby the conductivity of an electrode fabricated from coated electrode material 50, taken as a whole (as compared with other electrodes made with a coating of carbon). This occurs because when carbon materials (valence state +4) are doped with atoms of a higher valence state, e.g. nitrogen atoms or phosphorus atoms of valence state +5, one or more electrons from the dopant (nitrogen atoms or phosphorus atoms) will become freely mobile, thus improving electrical conductivity. The electrode conductivity improvement will facilitate the electron transportation during charge-discharge process.

Protective layer 501, according to embodiments of the invention, provides excellent coating stability. The chemical bonding between core active material 500 (e.g. metal oxide electrode material) and protective layer 501 helps to bring about this excellent coating stability. Further, the chemical bonding improves the conduction between core active materials 500 and shell protective layer 501.

Further yet, protective layer 501 is substantially uniform. In other words, the variation in thickness of protective layer 501, generated according to embodiments of the invention, is small. For example, the thickness variation is less than or equal to 20% when the layer is substantially uniform. It is believed that the chemical grafting reaction with organometallic additives and the chemical grafting reaction with a nitrogen and carbon source cause the uniform thickness of protective layer 501.

According to embodiments of the invention, protective layer 501's bi-functional coating improves electron transfer as a result of the non-metal element having a valency of +5 (e.g. nitrogen, phosphorus) dopants and, at the same time, provides material to react with harmful or corrosive by-products to prevent dissolution of materials from core active material 500. Although embodiments of the invention involve using a non-metal with a valency of +5, other non-metal having other valency may be used as dopants as an alternative to or in addition to the non-metal with a valency of +5. Thus, embodiments of the invention may include predetermining non-metals of a particular valency are appropriate (e.g. a valency of +5 or higher) and selecting, at least in part, based on such predetermining the non-metal to be used as a dopant.

Embodiments of the invention may include one type of dopant, e.g. metal dopant, metalloid dopant, nitrogen dopant, or phosphorus dopant. Embodiments of the invention may also include combinations of different types of the following dopants: metal dopant, metalloid dopant, nitrogen dopant, phosphorus dopant, other appropriate dopant, and combinations thereof. Therefore, according to embodiments of the invention, “doped” includes one or more types of dopants, e.g. uni-doped—single dopant; co-doped—two dopants, tri-doped—three dopants, etc.

View 52 is an exploded view of protective layer 501. View 52 shows that protective layer 501 includes metal atoms M′ located directly at the surface of core active material 500. That is, metal atoms M′ are at the innermost portion of protective layer 501. View 52 also shows nitrogen dopants in the outer layer of protective layer 501. The relative locations of the respective dopant atoms are as a result of the sequence in which the chemical grafting reactions, shown in process steps 402 and 403, take place. In embodiments of the invention, an electrode including core active material 500 coated with protective layer 501 is provided in a lithium ion battery such as lithium ion battery 60. The electrode (e.g. cathode 601) may be made from a slurry comprising 94% coated Li_{1.2}Mn_{0.6}Ni_{0.2}O₂ (lithium rich cathode material; LRCM), 3% acetylene carbon black (Super P) and 3% polyvinylidene fluoride (PVDF) in N-methyl-2-pyrrolidone (NMP). In embodiments of the invention, the resultant slurry may be uniformly spread onto aluminum foil (current collector) by a film applicator and vacuum dried at 120° C. for 12 hours to form the electrode. Lithium ion battery 60 includes cathode 601, fabricated from coated electrode material 50, electrolyte 602, separator 603 and anode 600. Cathode 601 comprises core active material 500 chemically bonded to protective layer 501, as described above. It should be noted that in embodiments of the invention, either electrode or both electrodes may include coated and protected core active material as described above. That is, either the cathode (e.g. cathode 601), the anode (e.g. anode 600), or both, may be fabricated from coated electrode material 50.

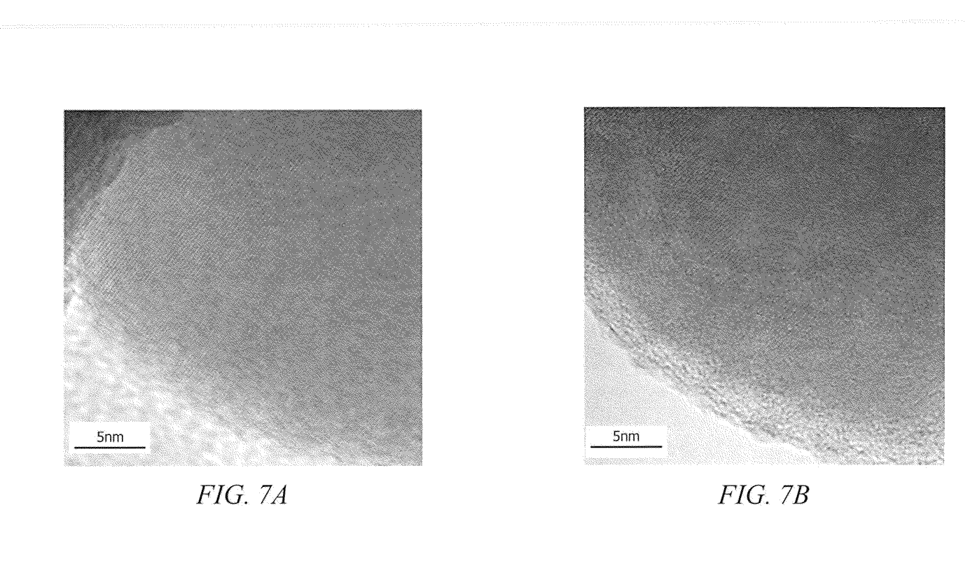

FIGS. 7A & 7B show electrode material (lithium rich cathode material (LRCM) Li_{1.2}Mn_{0.6} Ni_{0.2}O₂) before and after coating according to embodiments of the invention. FIG. 7A shows the core active material before coating with metalloid (silicon) nitrogen co-doped carbon. FIG. 7B shows the core active material after coating with metalloid (silicon) nitrogen co-doped carbon. A comparison of transmission electron microscopy (TEM) images before and after coating shows a contrast between the core active material and the coating layer. In FIG. 7B, the lighter area is the coating layer, which is a shell composite of co-doped carbon (carbon doped with silicon atoms (metalloid atoms) and nitrogen atoms). It should be noted that the coating is very uniform, with a typical thickness of about 3 nm.

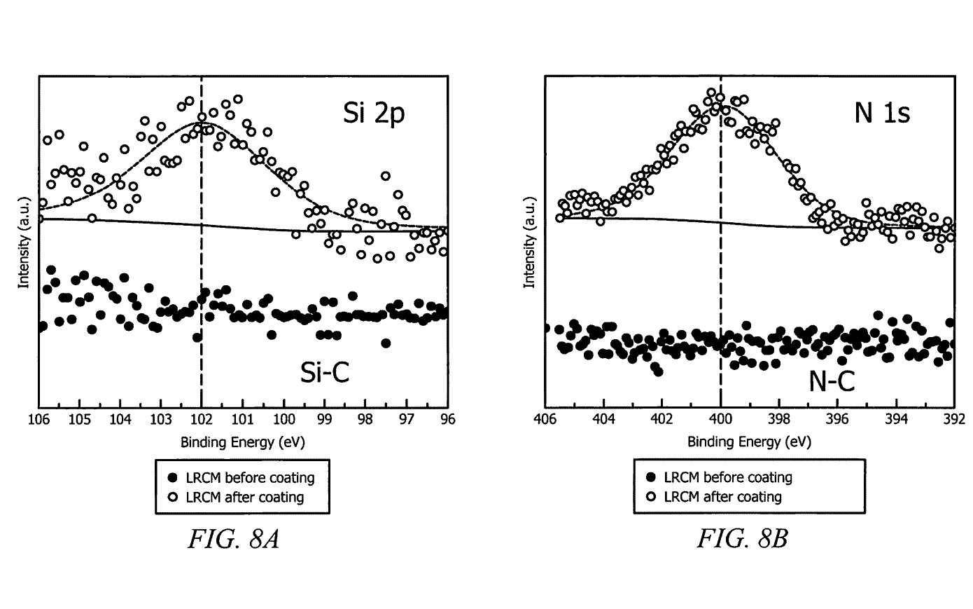

FIGS. 8A and 8B show X-ray photoelectron spectroscopy (XPS) pertaining to an electrode coated with silicon (metalloid)-nitrogen-co-doped carbon, according to embodiments of the invention. FIG. 8A shows high resolution Si2p XPS spectra of Li_{1.2}Mn_{0.6}Ni_{0.2}O₂ (lithium rich cathode material, LRCM) before (solid symbol) and after (open symbol) coating. FIG. 8B shows N1s XPS spectra of Li_{1.2}Mn_{0.6}Ni_{0.2}O₂ (lithium rich cathode material, LRCM) before (solid symbol) and after (open symbol) coating. The X-ray photoelectron spectroscopy (XPS) was used to measure the binding energy of elements such as silicon and nitrogen in the metal/metalloid-nitrogen-co-doped carbon of the coated electrode. For coated LRCM material, the binding energy located at 102 eV suggests the formation of Si—C bonds in the coating layers. And the binding energy centered at 400 eV confirms the presence of N—C bonds in coated LRCM material. Based on these results, it can be concluded that, in the metalloid-nitrogen-co-doped carbon, the silicon is chemically bound with the carbon, and the nitrogen is chemically bound with the carbon. No chemical bonds such as Si—C and N—C were detected for pristine LRCM material. Thus, it can be concluded that the metalloid and the nitrogen are co-doped in the coating layer by chemical bonding with the carbon.

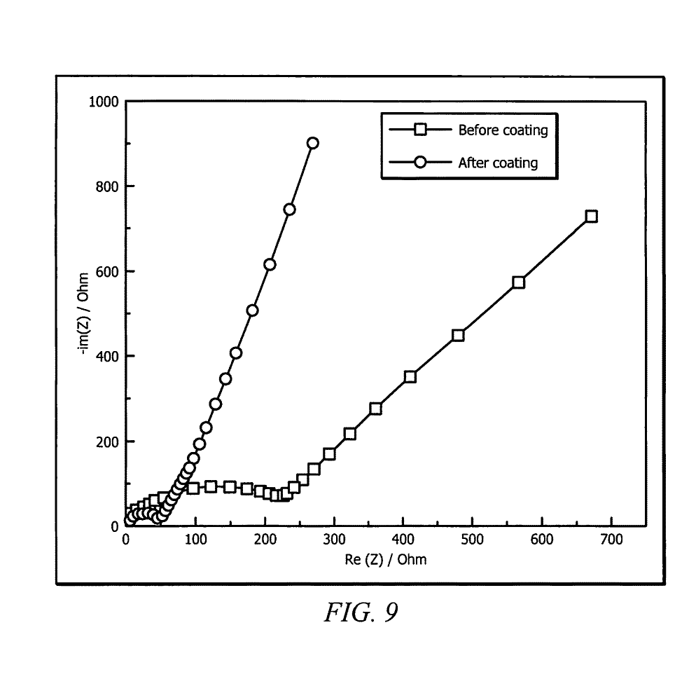

FIG. 9 shows a graph pertaining to an electrode before and after coating with metal/metalloid-nitrogen-co-doped carbon, according to embodiments of the invention. The EIS—electrochemical impedance spectroscopy analysis was conducted before and after coating with metal/metalloid-nitrogen-co-doped carbon, according to embodiments of the invention. As the graph shows, before the coating, the internal resistance in coin cell was estimated to be around 250 Ohm, and after coating it is estimated to be about 50 Ohm. Thus, there is an improvement of the conductivity of the materials as a result of metalloid-nitrogen-co-doped carbon coating. In an embodiment, in which (lithium rich cathode materials (LRCM) Li_{1.2}Mn_{0.6}Ni_{0.2}O₂) was coated with silicon and nitrogen co-doped carbon layers, the metal nitrogen co-doped carbon had a resistance change R₁/R₀ of 0.25, where R₁ is the resistance after coating the electrode and R₀ is the resistance before coating the electrode. The smaller the value of R₁/R₀ is, the bigger the change in the internal resistance of the coated material.

Further to the disclosure above, embodiments of the invention may include any combination of the following features (a) to (x) in a method or a product produced by steps of the method. The method may be for coating electrode materials for a lithium ion battery.

(a) Chemically bonding doped carbon to core active material.

(b) The doped carbon may be doped with at least (1) a metal or metalloid and (2) a non-metal having a valency different from carbon's valency (e.g. a valency of +5 or greater).

(c) The chemically bonding may include chemically bonding an organic layer to the core active material; and converting the organic layer to the doped carbon.

(d) Chemically bonding an organic layer may include protonating a surface of the core active material to create hydroxyl (—OH) groups on the surface.

(e) Chemically grafting with an organometallic additive to combine metal atoms or metalloid atoms to the protonated surface and form a first layer.

(f) Chemically grafting a source of carbon and the non-metal to the first layer to form a second layer of the organic layer.

(g) The protonating may involve reacting a metal oxide or metal phosphate of the core active material with an acid in solution with an organic solvent.

(h) The reacting of the metal oxide or metal phosphate with the acid may include chemically bonding hydrogen to the metal oxide or metal phosphate.

(i) The metal oxide or metal phosphate may include a selection from the group consisting of: LiCoO₂, LiNiO₂, LiMn₂O₄, LiFePO₄, LiNi₁₁₃Mn_{1/3}CO_{1/3}O₂, LiNi_{0.5}Mn_{0.3}Co_{0.2}O₂, xLi₂MO₃.(1−x)LiMeO₂ (0<x<1, M and Me are independently at least one from Mn, Ni, Co), Fe₃O₄, and SnO₂, and combinations thereof.

(j) The acid may include a selection from the group consisting of: acetic acid, oxalic acid, formic acid, citric acid, and combinations thereof.

(k) The organic solvent may include a selection from the group consisting of: methanol, ethanol, isopropanol, and acetone.

(l) The chemical grafting of metal atoms or metalloid atoms into the first layer may include reacting an organometallic additive with the protonated surface.

(m) The organometallic additive may include a selection from the group consisting of: silane, aluminum, titanium, zirconate, and combinations thereof.

(n) The coupling agents of the organometallic additives may include functional groups such as epoxy, alkoxy and amine, including bis[2-[(2-aminoethy)amino]ethanolato][2-[(2-aminoethyl)amino]ethanolato-O](propan-2-olato)titanate and (3-glycidyloxypropyl)trimethoxysilane, and combinations thereof.

(0) The metal atoms or the metalloid atoms may include a selection from the group consisting of: Ti, Al, Si, Sn, Mg, Zn, Zr, and combinations thereof.

(p) An innermost of the first layer may include the metal atoms or the metalloid atoms.

(q) The nitrogen and carbon source may include a selection from the group consisting of: melamine, polyethyleneimine, polyacrylamide, pyrrole, and combinations thereof

(r) An outermost of the second layer may include the nitrogen and carbon source or the phosphorus and carbon source.

(s) The organic layer may be heat treated in a carbonization process.

(t) The heat treating may include heating the organic layer to a temperature in a range of 400-1200° C. in an atmosphere selected from the group consisting of: argon, helium, nitrogen, hydrogen, carbon dioxide and combinations thereof.

(u) The carbon may be doped by a plurality of different types of atoms.

(v) The carbon may be co-doped carbon.

(w) The co-doped carbon may include (1) nitrogen or phosphorus and (2) metal or metalloid, as dopants.

(x) The doped carbon layer comprises self-doped carbon.

Further to the disclosure above, embodiments of the invention include any combination of the following features (1) to (11) in an apparatus or a system. The apparatus or system may be a lithium ion battery, electrode of a lithium ion battery, or material used to make an electrode of a lithium ion battery.

(1) The apparatus or system may include core active material having doped carbon chemically bonded to the core active material, in which the doped carbon is doped at least with (1) a metal or metalloid and (2) a non-metal having a valency different from carbon's valency (e.g. a valency of +5 or greater).

(2) The core active material may include a selection from the group consisting of: a metal oxide, a metal sulfide, a metal phosphate, and combinations thereof.

(3) An innermost layer of the doped carbon may include the metal atoms or the metalloid atoms.

(4) The metal atoms or the metalloid atoms may be selected from the group consisting of: Ti, Al, Si, Sn, Mg, Zn, and Zr.

(5) The outermost layer of the doped carbon may include the non-metal having a valency of +5.

(6) The non-metal having a valency of +5 may include nitrogen or phosphorus.

(7) The concentration of the nitrogen or the phosphorus in the doped carbon may be equal to or less than 5%.

(8) The concentration of the metal or the metalloid in the doped carbon is equal to or less than 5%.

(9) The doped carbon is a layer having a thickness of 2-50 nm.

(10) The doped carbon layer is substantially uniform such that if there is a variation in the layer's thickness, the variation is less than or equal to 20%.

(11) The doped carbon layer comprises self-doped carbon.

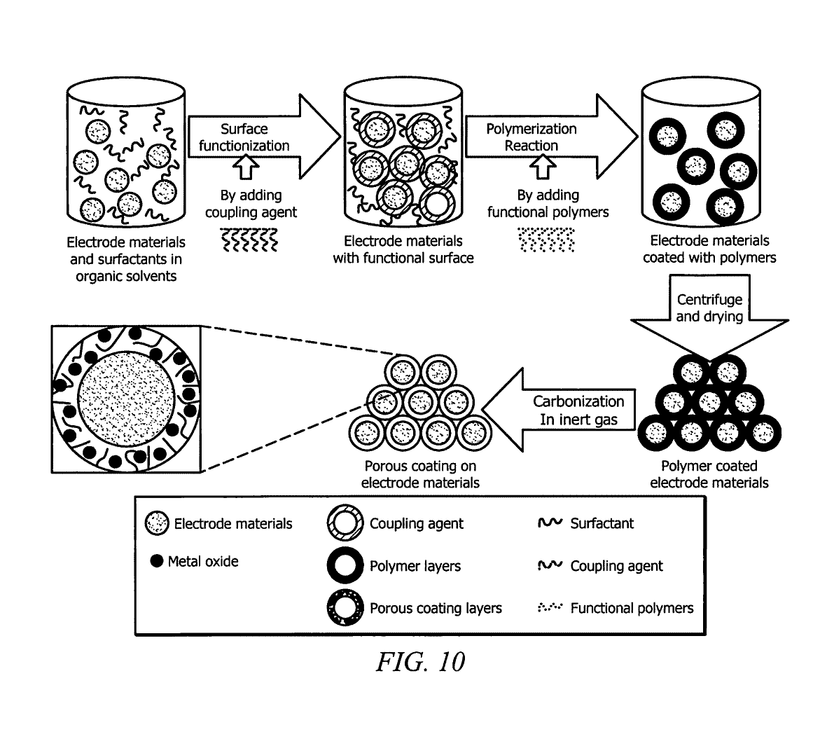

Embodiments of the disclosure provide a method to produce a coating comprising of metal oxides and three dimensional porous carbon matrixes onto electrode materials for lithium ion batteries. Typically, the coating structure is metal oxides embedded into porous carbon matrixes, as illustrated in FIG. 10. The weight percentages of carbon and metal oxides in the final product are 1˜10% and 0.1˜1%, respectively. The coating thickness is in the range of 20˜200 nm. In addition, due to the use of pore forming agents (e.g. surfactants), porous structures are also produced in the coatings. The pore size in the coating layers is 2˜50 nm.

Embodiments of the disclosure makes use of coupling agents (e.g. titanate coupling agent) to functionalize the surface of electrode materials suspended in solvents, followed by polymerization process with appropriate polymers to produce polymer wrapped electrode materials. The chemical bonding between coupling agent and active electrode materials enhance the uniform coating onto electrode materials. In order to create more pores in carbon coating, pore forming agents (e.g. surfactants) are also added in the polymerization process, which are performed at 80° C. to allow the evaporation of solvents. The polymer wrapped electrode materials are dried and subsequently carbonized in inert atmosphere at the temperature of about 1000° C. The coupling agents, polymers and surfactants are the sources of carbon materials and metal oxide (e.g. TiO₂) particles. The presence of metal oxides in the carbon coating layer plays the role as the scavenger of HF, which may generate decay during charge/discharge process in lithium ion batteries. The above-mentioned fabrication procedures are composed of the steps below and illustrated in FIG. 10 as follows.

(1) Surface functionalization of electrode materials. The electrode materials (e.g. silicon, lithium rich cathode materials, etc.) are homogeneously dispersed in organic solvent (e.g. alcohols) which contains organometallic coupling agent (e.g. M=Al and Ti) for the surface functionalization. In addition, triblock co-polymers as soft templates are added for the formation of porous structures in the coating layers.

(2) Polymerization on electrode surface. Suitable polymers with functional groups (e.g. —NH₂ or epoxy group) are added in the above solution for the growth of polymers onto the electrode surface at the temperature (e.g. 80° C.). The polymerization process is achieved between coupling agent and polymers by heat. The polymers are long chain hydrocarbons, having functional groups for the polymerization reaction with coupling agents.

(3) Carbonization in inert atmosphere. The as-formed polymer coated electrode materials may be collected and dried followed by carbonization. The powered composite materials may be carbonized at 1000° C. in an inert atmosphere (e.g. N₂) for coating metal oxide and carbon matrix onto electrode materials.

In step (1) above, the organometallic coupling agents can be silane or zirconate coupling agents. The organic solvent used in suspending active electrode materials can be methanol, ethanol, acetone or toluene. In step (2) above, the polymerization temperature can be in the range of 60˜200° C. In step (3) above, the carbonization temperature can be 4002000° C. and the inert atmosphere can be argon, helium or a mixture of them.

Conventional coating for electrode material is usually non-uniform layers with uncontrollable thickness, due to the physical mixing of electrode materials and coating sources, such as ball milling method. According to the present disclosure, the coating thickness and compositions can be controlled by varying the percentage of metal oxides and carbon contents in the shell. Also, due to the presence of strong chemical bonding between coupling agent and active electrode materials, a substantially uniform form coating layer can be achieved. Thus, a substantially uniform coating with controllable coating thickness and compositions can be achieved on the surface of electrode materials. This coating technology is expected to improve the electronic conductivity and provide protection for active electrode materials in lithium ion batteries.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for coating core active material for an electrode of a lithium ion battery, said method comprising:
chemically bonding doped carbon to said core active material, said doped carbon being doped with at least (1) a metal or a metalloid and (2) a non-metal having a valency different from carbon's valency, said chemically bonding comprising:
chemically bonding an organic layer to said core active material; and
converting said organic layer to said doped carbon.

2. The method of claim 1 wherein said chemically bonding said organic layer comprises:
protonating a surface of said core active material to create hydroxyl (—OH) groups on said surface; and
chemically grafting metal atoms or metalloid atoms to said protonated surface to form a first layer; and
chemically grafting a source of carbon and said non-metal to said first layer to form a second layer of said organic layer.

3. The method of claim 2 wherein said protonating comprises:
reacting a metal oxide or a metal phosphate of said core active material with an acid in solution with an organic solvent.

4. The method of claim 3 wherein said reacting said metal oxide or said metal phosphate with said acid comprises chemically bonding hydrogen to said metal oxide or said metal phosphate.

5. The method of claim 3 wherein said metal oxide comprises a selection from the group consisting of LiCoO₂, LiNiO₂, LiMn₂O₄, LiFePO₄, LiNi_{1/3}Mn_{1/3}Co_{1/3}O₂, LiNi_{0.5}Mn_{0.3}CO_{0.2}O₂, xLi₂MO₃.(1−x)LiMeO₂ (0<x<1, M and Me are independently at least one from Mn, Ni, Co), Fe₃O₄, and SnO₂, and combinations thereof.

6. The method of claim 3 wherein said acid comprises a selection from the group consisting of: acetic acid, oxalic acid, formic acid, citric acid, and combinations thereof.

7. The method of claim 3 wherein said organic solvent comprises a selection from the group consisting of: methanol, ethanol, isopropanol, and acetone.

8. The method of claim 2 wherein said chemically grafting said metal atoms or said metalloid atoms into said first layer comprises:
reacting an organometallic additive with said protonated surface.

9. The method of claim 8 wherein said organometallic additive comprises a selection from the group consisting of: silane, aluminum, titantium, zirconate, and combinations thereof.

10. The method of claim 8 wherein coupling agents of said organometallic additive comprises a functional group selected from the group consisting of: epoxy, alkoxy and amine, including bis[2-[(2-aminoethyl)amino]ethanolato][2-[(2-aminoethy)amino]ethanolato-O](propan-2-olato)titanate and (3-glycidyloxypropyl)trimethoxysilane, and combinations thereof.

11. The method of claim 8 wherein said metal atoms or said metalloid atoms comprises a selection from the group consisting of: Ti, Al, Si, Sn, Mg, Zn, Zr, and combinations thereof.

12. The method of claim 2 wherein an innermost of the first layer comprises said metal atoms or said metalloid atoms.

13. The method of claim 2 wherein said source of carbon and non-metal comprises a selection from the group consisting of: melamine, polyethyleneimine, polyacrylamide, pyrrole, and combinations thereof.

14. The method of claim 2 wherein an outermost of the second layer comprises said source of carbon and non-metal.

15. The method of claim 1 wherein said converting said organic layer comprises:
heat treating said organic layer in a carbonization process.

16. The method of claim 15 wherein said heat treating comprises:
heating said organic layer to a temperature in a range of 400˜1200° C. in an atmosphere selected from the group consisting of: argon, helium, nitrogen, hydrogen, and combinations thereof.

17. The method of claim 1 wherein said doped carbon is doped by a plurality of different types of atoms.

18. The method of claim 17 wherein said carbon is co-doped carbon.

19. The method of claim 18 wherein said co-doped carbon comprises nitrogen or phosphorus and metal or metalloid, as dopants.

20. The method of claim 1 wherein said doped carbon comprises self-doped carbon.

21. A lithium ion battery comprising:
an electrode that comprises:
core active material having doped carbon chemically bonded to said core active material, wherein said doped carbon is doped at least with (1) a metal or a metalloid and (2) a non-metal having a valency different from carbon's valency.

22. The battery of claim 21 wherein said core active material comprises a selection from the group consisting of: a metal oxide, a metal sulfide, a metal phosphate, and combinations thereof.

23. The battery of claim 21 wherein an innermost layer of the doped carbon comprises said metal or said metalloid.

24. The battery of claim 21 wherein said metal or said metalloid is selected from the group consisting of: Ti, Al, Si, Sn, Mg, Zn, and Zr.

25. The battery of claim 21 wherein an outermost layer of the doped carbon comprises said non-metal and said non-metal has a valency of +5.

26. The battery of claim 25 wherein said non-metal having a valency of +5 comprises nitrogen or phosphorus.

27. The battery of claim 26 wherein a concentration of said nitrogen or said phosphorus in said doped carbon is equal to or less than 5%.

28. The battery of claim 21 wherein a concentration of said metal or said metalloid in said doped carbon is equal to or less than 5%.

29. The battery of claim 21 wherein said doped carbon comprises a selection from the group consisting of: a layer having a thickness of 2˜50 nm.

30. The battery of claim 21 wherein said doped carbon comprises a layer that is substantially uniform such that if there is a variation in said layer's thickness, the variation is less than or equal to 20%.

31. The battery of claim 21 wherein said doped carbon comprises self-doped carbon.

32. Material for fabricating an electrode of a lithium ion battery, said material comprising:
core active material having doped carbon chemically bonded to said core active material, wherein said doped carbon is doped at least with (1) a metal or a metalloid and (2) a non-metal having a valency different from carbon's valency.

33. The material of claim 32 wherein said core active material comprises a selection from the group consisting of: a metal oxide, a metal sulfide, a metal phosphate, and combinations thereof.

34. The material of claim 32 wherein an innermost layer of the doped carbon comprises said metal or said metalloid.

35. The material of claim 32 wherein said metal or said metalloid is selected from the group consisting of: Ti, Al, Si, Sn, Mg, Zn, and Zr.

36. The material of claim 32 wherein an outermost layer of the doped carbon comprises said non-metal and said non-metal has a valency of +5.

37. The material of claim 36 wherein said non-metal having a valency of +5 comprises nitrogen or phosphorus.

38. The material of claim 37 wherein a concentration of said nitrogen or said phosphorus in said doped carbon is equal to or less than 5%.

39. The material of claim 32 wherein a concentration of said metal or said metalloid in said doped carbon is equal to or less than 5%.

40. The material of claim 32 wherein said doped carbon comprises a layer having a thickness of 2˜50 nm.

41. The material of claim 32 wherein said doped carbon comprises a layer that is substantially uniform such that if there is a variation in said layer's thickness, the variation is less than or equal to 20%.

42. The material of claim 32 wherein said doped carbon comprises self-doped carbon.

43. A product for fabricating an electrode of a lithium ion battery made by a process comprising the steps of:
chemically bonding doped carbon to core active material, said doped carbon being doped with at least (1) a metal or a metalloid and (2) a non-metal having a valency different from carbon's valency, said chemically bonding comprising:
chemically bonding an organic layer to said core active material; and
converting said organic layer to said doped carbon.

44. The product of claim 43 wherein said chemically bonding said organic layer comprises:
protonating a surface of said core active material to create hydroxyl (—OH) groups on said surface; and
chemically grafting metal atoms or metalloid atoms to said protonated surface to form a first layer; and
chemically grafting a source of carbon and said non-metal to said first layer to form a second layer of said organic layer.

45. The product of claim 44 wherein said protonating comprises:
reacting a metal oxide or a metal phosphate of said core active material with an acid in solution with an organic solvent.

46. The product of claim 45 wherein said reacting said metal oxide or said metal phosphate with said acid comprises chemically bonding hydrogen to said metal oxide or said metal phosphate.

47. The product of claim 44 wherein said chemically grafting said metal atoms or said metalloid atoms into said first layer comprises:
reacting an organometallic additive with said protonated surface.

48. The product of claim 44 wherein an innermost of the first layer comprises said metal atoms or said metalloid atoms.

49. The product of claim 44 wherein an outermost of the second layer comprises said source of carbon and non-metal.

50. The product of claim 43 wherein said converting said organic layer comprises:
heat treating said organic layer, to a temperature in a range of 400˜1200° C. in an atmosphere selected from the group consisting of: argon, helium, nitrogen, hydrogen, and combinations thereof, in a carbonization process.

51. The product of claim 43 wherein said doped carbon is self-doped with at least: (1) nitrogen or phosphorus and (2) metal or metalloid.

52. The product of claim 43 wherein said product comprises Li_{1.2}Mn_{0.6}Ni_{0.2}O₂ nanoparticles coated with said doped carbon.
